(19) United States
(12) Patent Application Publication
(10) Pub. No.: US 2023/0055934 A1
(43) Pub. Date: Feb. 23, 2023

(54) DIAPHRAGM-TYPE DEPLOYMENT DEVICE, PARTICULARLY FOR HOROLOGY

(71) Applicant: Montres Breguet S.A., L'Abbaye (CH)

(72) Inventor: Marc STRANCZL, Nyon (CH)

(73) Assignee: Montres Breguet S.A., L'Abbaye (CH)

(21) Appl. No.: 17/815,785

(22) Filed: Jul. 28, 2022

(30) Foreign Application Priority Data
Aug. 20, 2021 (EP) 21192341.2

(51) Int. Cl. G04B 45/02; G04B 19/06

(52) U.S. Cl. CPC G04B 45/02; G04B 19/065

(57) ABSTRACT

A diaphragm-type deployment device, particularly for horology, the device including a first rigid armature and a second deformable armature, the first rigid armature and the second deformable armature being connected to one another, so that the second deformable armature changes from a first extended configuration to a second compact configuration, and vice versa, the device defining a first geometry when the second deformable armature is in the first extended configuration, and defining a second geometry smaller than the first geometry, when the second deformable armature is in the second compact configuration, the device extending substantially in the same plane when the second armature is in the first or in the second configuration, wherein the second deformable armature includes first deformable portions and rigid portions assembled alternately, a first deformable portion connecting a rigid portion to a following rigid portion. The device also relates to a timepiece including such a display device.

### TECHNICAL FIELD OF THE INVENTION

The invention relates to a diaphragm-type deployment device, particularly for horology.

The invention also relates to a timepiece including such a deployment device.

### TECHNOLOGICAL BACKGROUND

Diaphragm-type deployment devices are elements having an armature that may change from a compact configuration, wherein the device has a small volume or geometry, to an extended configuration, wherein the device has a larger volume or geometry.

These devices are often used in horology, in particular in display devices or in devices for driving, or even for locking the axis of rotation of a wheel.

In display devices, they may be used as removable screens to conceal a portion or all of the information shown by the display device. In the compact configuration, the information is uncovered in order to be visible, for example by the wearer of a watch comprising the display device, whereas in the extended position, the device covers the information.

Examples of display devices are shown in documents CH46061, CH711228, DE29521914, DE1985554 or EP1842112.

In another example of application, the document EP3671370 shows a deployment device for coupling two superposed rotary elements. In the compact configuration, the two elements are coupled by the deployment device in contact with the two elements in order that one of the elements rotates the other element. In extended configuration, the two elements are uncoupled, so that the rotation of one does not drive the rotation of the other.

Other applications are also possible, for example in a system for locking the rotation of a balance of a regulator organ. In the extended configuration, the deployment device actuates a locking lever of the balance, whereas in the compact configuration, the lever is no longer actuated, in such a way as to leave the balance in motion.

However, the actuation of such diaphragm-type deployment devices is difficult, because it requires complex articulations to be able to act on the device and make it change configuration. Indeed, they are formed of a multiplicity of elements joined by articulations, particularly forming pivots between said portions.

Yet, these articulations make the device slow to actuate when it is desired to change from one configuration to the other.

### SUMMARY OF THE INVENTION

The aim of the invention is to remedy the aforementioned drawbacks, and aims to provide a diaphragm-type deployment device, the actuation of which is simple and fast.

To this end, the invention relates to a diaphragm-type deployment device, particularly for horology, the deployment device including a first rigid armature and a second deformable armature, the first rigid armature and the second deformable armature being connected to one another, so that the second deformable armature changes from a first extended configuration to a second compact configuration, and vice versa, the device defining a first geometry when the second armature is in the first extended configuration, and defining a second geometry smaller than the first geometry, when the second armature is in the second compact configuration, the device extending substantially in the same plane when the second armature is in the first or in the second configuration.

The deployment device is noteworthy in that the second deformable armature comprises first deformable portions and rigid portions assembled alternately, a first deformable portion connecting a rigid portion to a following rigid portion.

Thus, the device is easy to use thanks to the combination of deformable portions and of rigid portions, because the rigid portions may be moved to actuate the device more rapidly. Indeed, action is then applied directly on the deformable armature, which may be extended or compacted effectively. In addition, this combination makes it possible to use deformable portions, such as flexible strips, by keeping a device sufficiently rigid for applications requiring a bend resistance, for example in locking systems.

According to a particular embodiment of the invention, the whole of the first rigid armature and the whole of the second deformable armature form the first one-piece assembly.

According to a particular embodiment of the invention, a second portion of the first rigid armature and a second portion of the second deformable armature form a second one-piece assembly.

According to a particular embodiment of the invention, the first assembly and the second assembly are superposed on one another.

According to a particular embodiment of the invention, the second deformable armature comprises at least two movable shutters, preferably four movable shutters, the shutters being distributed by angular symmetry.

According to a particular embodiment of the invention, the shutters delimit the first opening of the first configuration and the second opening of the second configuration.

According to a particular embodiment of the invention, the material of the device is to be selected from silicon, an Ni/P-type nickel-phosphorus alloy, an Fe/Ni/Co/Mo-type steel alloy.

According to a particular embodiment of the invention, the second deformable armature comprises first deformable portions and rigid portions assembled alternately in series.

According to a particular embodiment of the invention, a first deformable portion connects a rigid portion to a following rigid portion.

According to a particular embodiment of the invention, the second deformable armature comprises at least one second deformable portion, preferably a plurality of second deformable portions, connecting one or more rigid portions to the first rigid armature.

According to a particular embodiment of the invention, the second deformable portions connect one rigid portion out of two to the first rigid armature.

According to a particular embodiment of the invention, the rigid portions connected to the first rigid armature have different shapes from the other rigid portions.

According to a particular embodiment of the invention, each deformable portion comprises a flexible strip connecting by its ends two rigid portions, or a rigid portion and the first rigid armature.

According to a particular embodiment of the invention, the device comprises means for moving at least one rigid portion, preferably a plurality of rigid portions, in order to make the second armature change from the extended configuration to the compact configuration and vice versa.

According to a particular embodiment of the invention, the rigid portion(s) moved by the movement means are rigid portions connected to the first rigid armature.

According to a particular embodiment of the invention, the rigid portion(s) moved by the movement means are rigid portions that are not connected to the first rigid armature.

According to a particular embodiment of the invention, the movement means are configured to produce a substantially straight movement of the rigid portion(s).

According to a particular embodiment of the invention, the movement means are configured to produce a rotary movement of the rigid portion(s).

According to a particular embodiment of the invention, the rigid portions connected to the first rigid armature are subjected to a rotary movement about a pivot point when the second armature changes from the extended configuration to the compact configuration and vice versa.

According to a particular embodiment of the invention, the second deformable armature delimits the outer perimeter of the diaphragm, the first rigid armature being arranged inside said perimeter.

According to a particular embodiment of the invention, the first rigid armature delimits the outer perimeter of the diaphragm, the second armature being arranged inside said perimeter.

According to a particular embodiment of the invention, the first geometry defines a first opening when the second deformable armature is in the first extended configuration, and the second geometry defines a second opening, when the second deformable armature is in the second compact configuration, the first opening being narrower than the second opening.

According to a particular embodiment of the invention, each shutter is arranged on a rigid portion different from the second deformable armature.

According to a particular embodiment of the invention, the first geometry defines a first perimeter when the second deformable armature is in the first extended configuration, and the second geometry defines a second perimeter, when the second deformable armature is in the second compact configuration, the first perimeter being larger than the second perimeter.

According to a particular embodiment of the invention, the second deformable armature comprises at least one sabot, preferably four sabots for delimiting the variable perimeter of the device, each sabot being arranged on a rigid portion different from the second deformable armature.

According to a particular embodiment of the invention, the diaphragm forms a cam the geometry of which is variable.

The invention also relates to a movement of a timepiece including such a deployment device.

### BRIEF DESCRIPTION OF THE FIGURES

Other specific features and advantages will become clearly apparent from the following description made hereafter, by way of indicative and non-limiting example, with reference to the appended drawings, wherein:

FIG. 1 is a schematic representation of a diaphragm-type deployment device without shutters, according to a first embodiment of the invention;

FIG. 2 is a schematic representation of the diaphragm-type deployment device of the first embodiment of the invention in compact configuration with shutters;

FIG. 3 is a schematic representation of the diaphragm-type deployment device of the first embodiment of the invention in intermediate configuration with shutters;

FIG. 4 is a schematic representation of the diaphragm-type deployment device of the first embodiment of the invention in extended configuration with shutters;

FIG. 5 is a schematic representation of the diaphragm-type deployment device of the first embodiment of the invention applied to a system for locking the balance arbor;

FIG. 6 is a schematic representation of a diaphragm-type deployment device according to a second embodiment of the invention;

FIG. 7 is a schematic representation separated from the diaphragm-type deployment device of the second embodiment of the invention;

FIG. 8 is a schematic representation of a layer of the diaphragm-type deployment device of the second embodiment of the invention;

FIG. 9 is a schematic representation of the diaphragm-type deployment device of the second embodiment of the invention in compact configuration;

FIG. 10 is a schematic representation of the diaphragm-type deployment device of the second embodiment of the invention in intermediate configuration;

FIG. 11 is a schematic representation of the diaphragm-type deployment device of the second embodiment of the invention in extended configuration;

FIG. 12 is a schematic representation of a diaphragm-type deployment device according to a third embodiment of the invention;

FIG. 13 is a schematic representation of the diaphragm-type deployment device of the third embodiment of the invention in compact configuration; and

FIG. 14 is a schematic representation of the diaphragm-type deployment device of the third embodiment of the invention in extended configuration.

### DETAILED DESCRIPTION OF THE INVENTION

The invention relates to a diaphragm-type deployment device 1, 10, 20, particularly for horology. In the embodiments below, the diaphragm-type deployment device is for example a display device of a timepiece, for example in a horological movement of a watch.

The deployment device comprises a first rigid armature 2 and a second deformable armature 3. Rigid means an armature that is not designed to be flexible in a normal use of this device 1, 10, 20, whereas the deformable armature is designed to deform during the use of the device 1, 10, 20.

The first rigid armature 2 comprises a square-shaped frame 4, each side being formed for example by an arm. The frame 4 defines an inner space wherein the second deformable armature 3 is arranged. Thus, the first rigid armature 2 delimits the outer perimeter of the device 1, whereas the second flexible armature 3 is arranged inside said perimeter.

Due to its flexibility, the second deformable armature 3 may change from a first extended configuration to a second compact configuration. The device 1 extends substantially in the same plane, when the second deformable armature 3 is in the first or in the second configuration.

The second deformable armature 3 has an arrangement comprising flexible portions 7, 8 and rigid portions 5, 6. The flexible portions 7, 8 connect the rigid portions 5, 6 together or connect rigid portions 5, 6 to the first rigid armature 2.

Each flexible portion 7, 8 comprises a flexible strip connected, either to the first rigid armature 2 by an end and to a rigid portion 5, 6 by the other end, or to two rigid portions 5, 6, by an end for each rigid portion 5, 6. The flexible strips preferably have a longitudinally elongated straight shape.

The rigid portions are rigid arms 5, 6, which may be either straight 6 or forming a U.

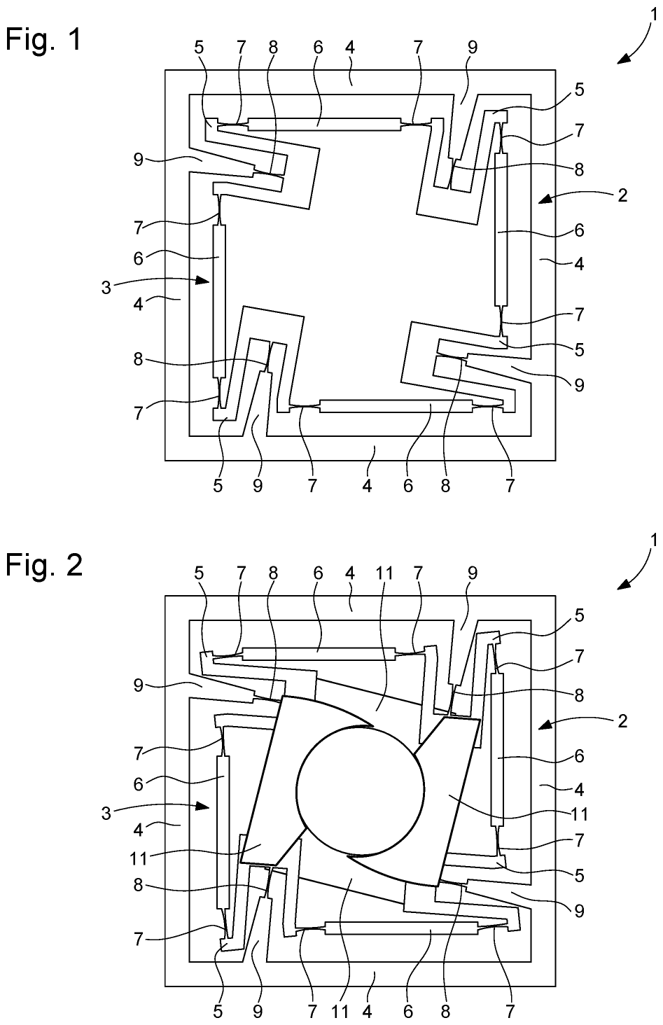

According to the invention, in the embodiment of FIGS. 1 to 5, the second deformable armature 3 comprises alternately in series, a rigid arm and a flexible strip. More specifically, the deformable armature comprises in series, a group comprising in series a U-shaped rigid arm 5, a first straight flexible strip 7, a straight rigid arm 6, and a second flexible strip 7. The free ends of the flexible strips 7 are joined at the free ends of the rigid arms 5, 6. The flexible strips 7 and the straight arm 6 are substantially co-linear, whereas the U is arranged perpendicular to the strips in the plane of the second flexible armature. The end of the arms of the U is arranged at the end of the flexible strips 7, its base being substantially parallel to the straight rigid arm 6. The inside of the U is oriented towards the first rigid armature 2. The first rigid armature 2 comprises a catch 9 extending from each side towards the inside of each U of the second deformable armature 3.

The second deformable armature 3 thus comprises four groups placed in series to form a square inside the frame 4 of the first rigid armature 2, each group running along one side of the frame 4 to the inside of the space of the frame 4. The groups are perpendicular to one another. Each assembly comprises a rigid U-shaped arm, a first flexible strip 7, a straight rigid arm 6, and a second flexible strip 7.

The second deformable armature 3 is connected to the first rigid armature 2 by third flexible strips 8 arranged in the extension of the catch 9, each flexible strip 8 connects the end of the catch 9 to the base of the U by penetrating into the space defined by the U.

Thus, the first rigid armature 2 and the second deformable armature 3 are joined to one another by anchoring points defined at the end of each catch. These anchoring points locally define axes of rotation about which the deformable armature may rotate when it deforms.

The device 1 comprises a shutter 11 arranged on each U-shaped rigid portion 5, preferably supported by the base of the U. The shutters 11 extend towards the centre of the device 1 to define an opening. The embodiment of FIGS. 1 to 4 comprises two opposite pairs of shutters 11 disposed perpendicular to one another. Each shutter 11 is arranged on the base of the U. A shutter has an elongated shape the free end of which moves apart with a hook-shaped rounded edge oriented towards the centre of the device 1. Two opposite shutters 11 are substantially symmetrical in relation to the centre of the device 1. The shutters are distributed by angular symmetry according to an angle α between two shutters, where

$$a = \frac{360}{n} ;$$

with n the number of shutters.

Each shutter 11 covers or is partly covered by the adjacent shutter 11. Thus, the rounded edges of the shutters form a substantially circular opening according to the layout of the shutters in relation to one another.

Preferably, the first rigid armature 2 and the second deformable armature 3 form at least partially a one-piece assembly. Here, the whole first rigid armature 2 and the whole second deformable armature 3 form the one-piece assembly. The two armatures form a single continuous part in one piece.

Preferably, the two armatures come from the same material. The material of the device 1 is for example to be selected from silicon, an Ni/P-type nickel-phosphorus alloy or an Fe/Ni/Co/Mo-type steel alloy.

Thus, the two armatures 2, 3 are manufactured in the same method to save time and lower the manufacturing cost. Optionally, the shutters are also formed in one piece with the two armatures 2, 3, in the same material.

For the silicon, the device 1 is preferably manufactured by a DRIE (Deep Reactive Ion Etching) type method.

A conventional LIGA-type photolithographic method is used to form the device 1 made of nickel-phosphorus alloy, or steel alloy.

The device 1 comprises movement means, not shown in the figures, configured to change the second deformable armature 3 from the compact configuration to the extended configuration and vice versa. These movement means may also be produced by flexible elements.

To this end, the movement means exert a movement on at least one rigid portion of the second deformable armature 3.

Preferably, in this embodiment, the movement is exerted on a straight rigid arm 6. Preferably, the movement means exert a force on a plurality of straight rigid arms 6 of the second deformable armature 3.

The movement means comprise for example a control rod, which is connected by a rod arranged through an opening in the straight rigid arm 6. By actuating the control rod, the rod pulls or pushes the straight rigid arm 6.

The movement means are configured to produce a substantially straight movement of the straight rigid portion(s) 6 of the second group. Preferably the movement is performed in the longitudinal direction of the straight arms 6.

By moving these rigid portions, the U-shaped rigid portions 5 also move by means of flexible strips 7 that connect them to the straight rigid arms 6.

The U-shaped rigid portions 5 perform a rotation about the anchoring points thanks to the flexible strips 8 that connect them to the catches 9 of the first rigid armature 2. Thus, the shutters 11 move and change position according to the configuration of the device 1.

The device 1 defines a first opening when the second deformable armature 3 is in the first extended configuration, and it defines a second opening when the second deformable armature 3 is in the second compact configuration. The first opening being narrower than the second opening.

As shown in FIG. 2, the second deformable armature 3 is in compact position, so that the shutters 11 are moved apart to form a wide opening. The straight rigid portions 6 are longitudinally close to the first rigid armature.

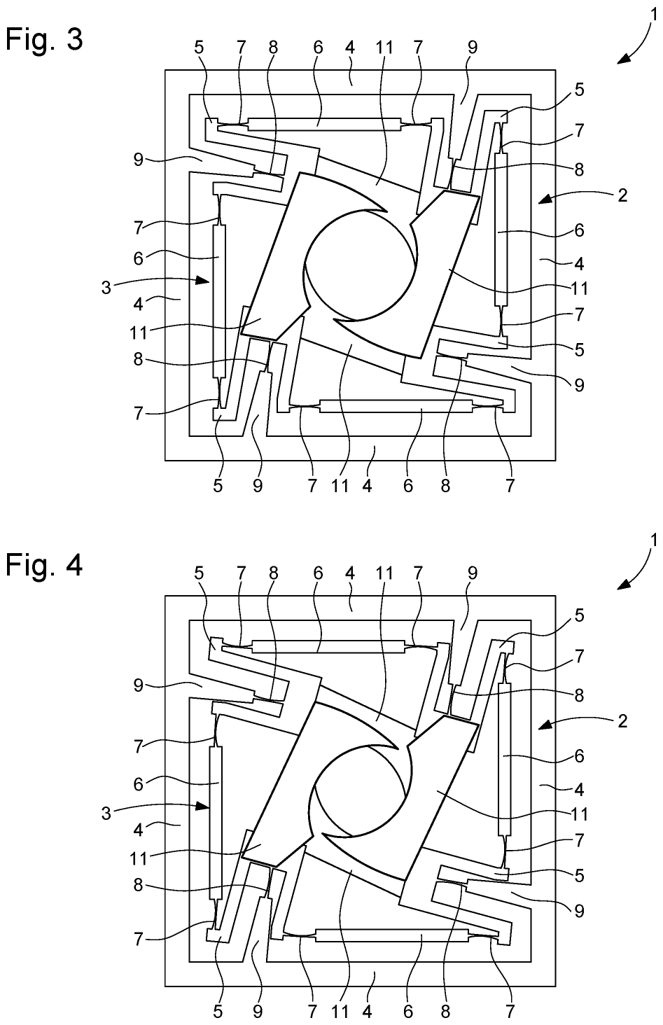

In FIG. 3, the second deformable armature 3 is in an intermediate position, the straight rigid portions 6 having been moved longitudinally to move them apart from the first rigid armature 2. Thus, the opening of the device is narrower than the opening of the device 1 of FIG. 1.

In addition, in FIG. 4, the second deformable armature 3 is in the extended position, the straight rigid portions 6 being moved even more apart longitudinally from the first rigid armature 2. Thus, an even narrower opening is obtained.

Preferably, the intermediate position is selected as rest position of the device, to be able to change into the extended position or into the compact position more rapidly. Indeed, the movement from the rest position to one of the two other positions is shorter, regardless of whether one of these two positions is selected as rest position.

In a particular embodiment, the shutters 11 may overlap and completely close the opening, in order to form a screen without opening. The device 1 is completely closed in the extended configuration of the second flexible armature 3, for example in the case of a display device 1, where the diaphragm hides an item of information, such as the date or the time.

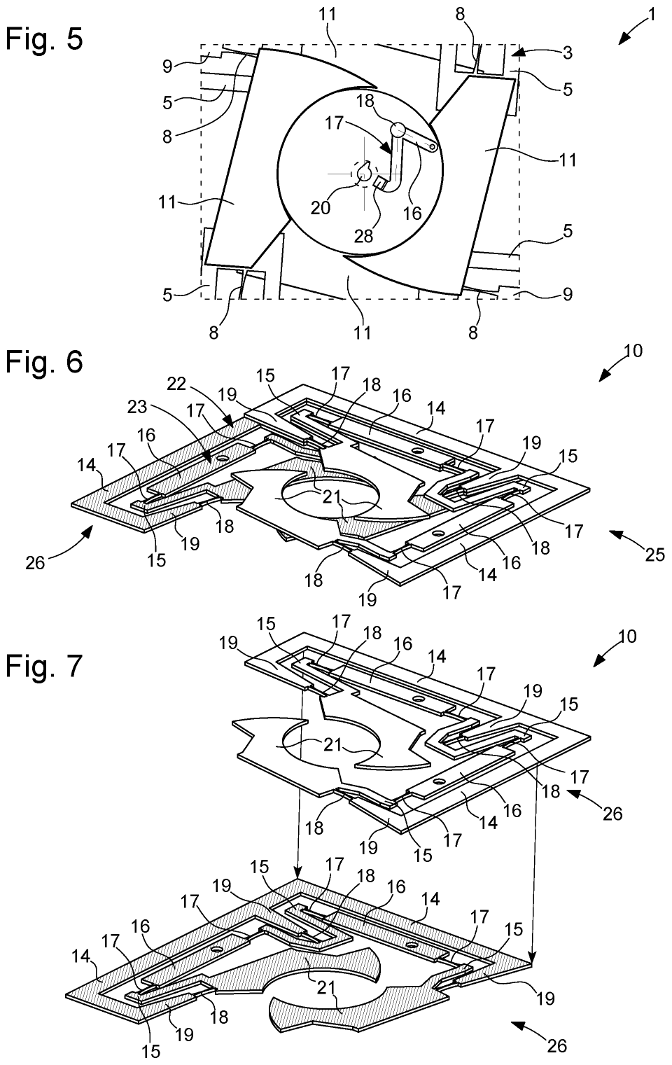

FIG. 5 is an example of application of the diaphragm-type deployment device 1, applied to a system for locking a tourbillon-type balance. In the extended position, the shutters 11 are directed towards the inside of the circle to come into contact with the control rod 16 of the stop-lever 17 in order to rotate the stop-lever 17 about its axis of rotation 18 with a stop portion at its end opposite the control rod 16, to come into contact with a cam 20 on the arbor of the sprung balance in such a way as to stop it momentarily to reset the time of the watch. This stop-lever 17 may momentarily stop the operation of the watch by locking the sprung balance at its axis of rotation 18, for example in contact with a balance stop cam 20 on the arbor of the sprung balance 14. The stop-lever 17 is for example held in a rest position by a spring fixed on the one hand by the stop-lever 17 between the control rod 16 and the axis of rotation 18, and on the other hand is fixed on the carriage support.

In the second embodiment of FIGS. 6 to 9, the rigid 12 and deformable armatures 13 are produced on two superposed layers 25, 26, the layers defining a first and a second superposed assembly. A first layer comprises a first portion of rigid 12 and deformable armatures 13, as well as two shutters 21, whereas the second layer comprises a second portion of rigid 12 and deformable armatures 13, as well as shutters 21. The two layers have in common a piece of the deployment device 1, which comprises everything between two catches of the rigid armature. In other words, one side of the device is reproduced in double, once on each side of the device 10.

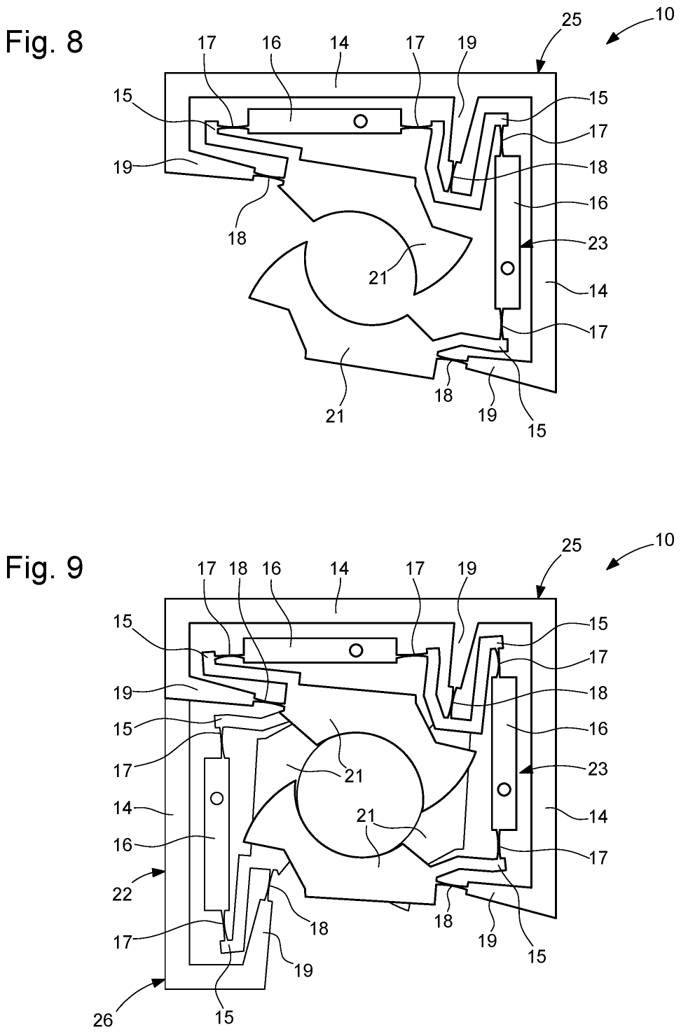

In FIGS. 7 and 8, for the rigid armature 12, the first layer 25 includes one side of the device 10, as well as the corner up to the catch 19 of a second side, and a third opposite side, up to the following catch 19. For the deformable armature 13, the first layer 25 comprises the elements extending from half of the U-shaped rigid portion 15 corresponding to the second side up to half of the U-shaped rigid portion 15 corresponding to the third opposite side. Furthermore, the first layer 25 includes two shutters 21 extending from each half of the U-shaped rigid portion 25.

The second layer 26 comprises the same configuration rotated 90°, here towards the left. Thus, in relation to the device 1 of the first embodiment, each layer 25, 26, comprises a whole side, as well as a quarter of a side and three quarters of sides at two corners of the whole side.

To form the device 10, the two layers 25, 26 are superposed, in contact with one another. The two layers 25, 26 forming an angle of 90° between them. Certain sides are formed by a single layer, whereas only one side is formed both in the two layers 25, 26.

The two superposed layers 25, 26 form a device 10 truncated in relation to the first embodiment of the device 1 of FIGS. 1 to 5, wherein a section of one side in the rigid armature 12 between two catches 19, and a section of the deformable armature 13 between two halves of U-shaped rigid portions 15 are missing. Thus, a corner of the frame, as well as two flexible strips 17 and a straight rigid portion 16 in addition to two halves of U-shaped rigid portion 15 are missing.

The operation of the device 10 is the same as for that 1 of the first embodiment. When the three straight rigid portions 16 are moved longitudinally, the second deformable armature 13 extends or compresses. The two opposite straight rigid portions 16 are moved in the opposite direction, whereas the third is moved perpendicularly in one direction or in the other according to the desired configuration.

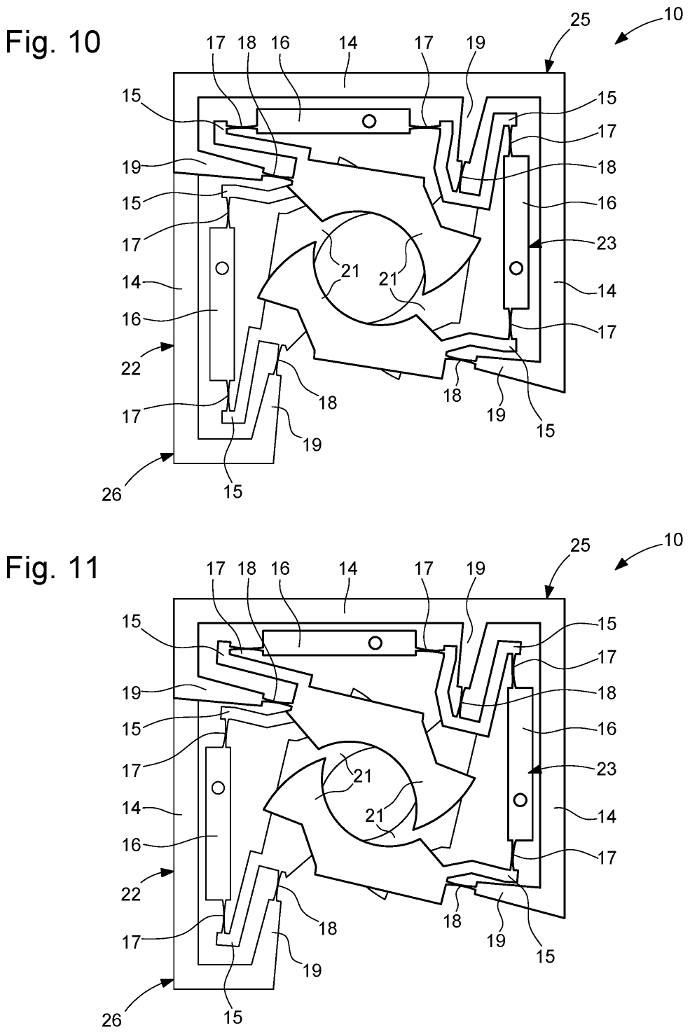

In FIG. 9, the extended configuration, the opening formed by the shutters 21 is wide. The opening is narrower in an intermediate position of the device 10, such as shown in FIG. 10. In the compact configuration of FIG. 11, the opening is narrower.

The actuation of the device of this embodiment may be performed by means of a pin passing through the two rigid elements 16 of the two layers 25, 26. The pin is for example actuated by a movable control arm including an oblong hole wherein the pin is inserted.

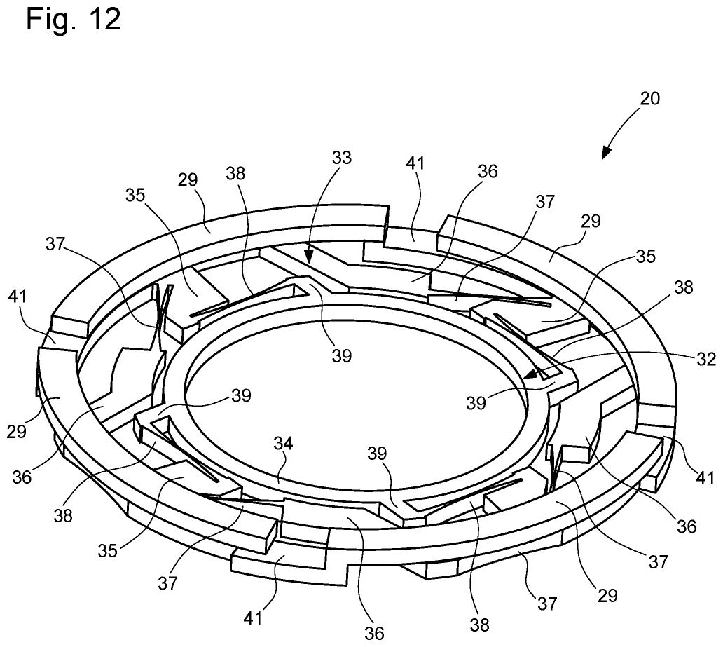

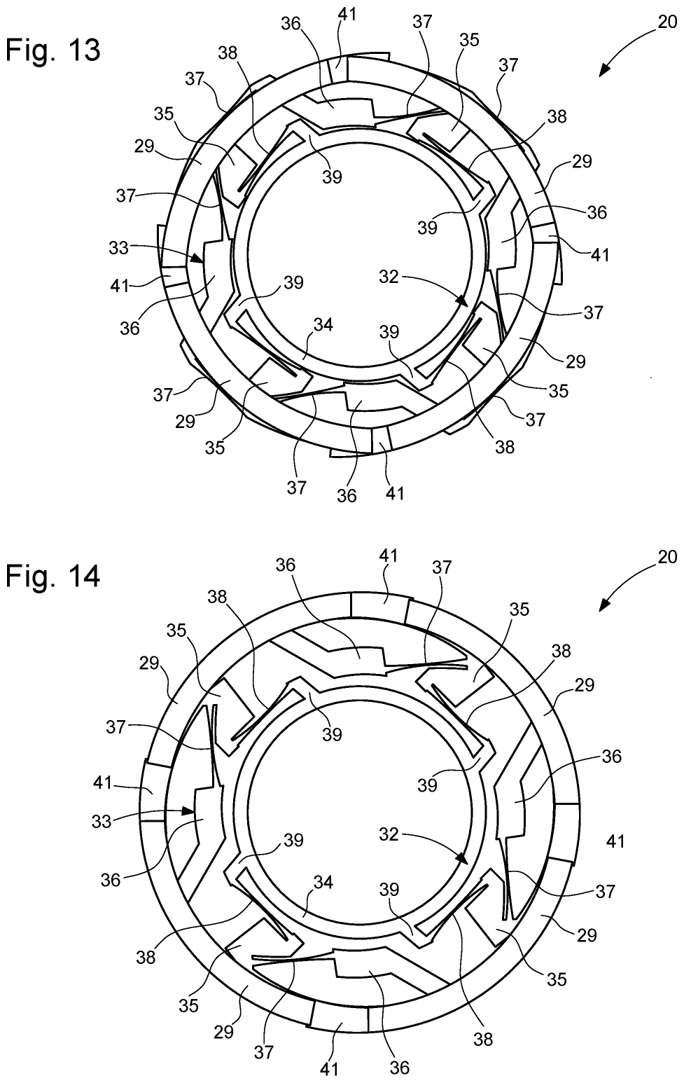

The third embodiment of the diaphragm-type deployment device 20, shown in FIGS. 12 to 14, comprises a central in the form of a ring equipped with catches 39 distributed angularly around the ring, on its outer side. The deformable armature extends towards the outside around the rigid armature. The second deformable armature 33 delimits the outer perimeter of the diaphragm, the first armature 32 being arranged inside said perimeter. The device 20 is substantially flat and mainly extends in one plane.

According to the invention, the second deformable armature 33, comprises rigid portions 35, 36 and flexible portions 37, 38. The second deformable armature 33 comprises first 35 and second rigid portions 36, preferably four each, which are distributed alternately around the ring. The first rigid portions 35 have a triangular shape with an outer protuberance and an anterior protuberance with two opposite apices. In addition, the second rigid portions 36 have an elbowed elongated shape.

The flexible portions comprise flexible strips 37, 38 connecting the rigid portions 35, 36 together, as well as the first rigid portions 35 to the catches 39 of the central ring. A first flexible strip 38 is arranged in series between a protuberance of the triangle and a catch 39, whereas a second flexible strip 37 is arranged between the other protuberance and an outer end of the elbowed rigid portion 36. Finally, a third strip 37 is arranged in series between the other end of the elbowed rigid portion 36 and the outer protuberance of the first rigid portion 35.

The device 20 further comprises a plurality of arc-shaped sabots 29, here 4, each arranged on the triangular rigid portion 35. The sabots 29 are preferably integral with each triangular rigid portion 35, and extend from the outer excrescence of the triangular rigid portion 35. The sabots 29 form the circular periphery of the device, which moves apart from the ring, when the deformable armature extends, and which moves closer to the ring, when the deformable armature is compact.

Each sabot 29 comprises a stepping 41 to be able to be partially superposed on the arc of the adjacent sabot 29. Regardless of the configuration of the device 20 in compact or extended position, the sabots 29 are more or less superposed. Thus, the sabots 29 may move in relation to one another, while forming a continuous barrier around the device 20, regardless of its configuration. This barrier may come into contact with other elements of the horological movement to trigger or lock a mechanism.

In extended position of the device 20, the sabots form a substantially circular barrier around an axis, whereas in compact position of the device 20, the sabots 29 are out of alignment with one another, while keeping an overlap between adjacent sabots 29.

For this embodiment, the whole first rigid armature 32 and the whole second deformable armature 33 form a one-piece assembly.

In this embodiment, the movement means are connected to the first rigid portions 35, in such a way as to impart a rotary movement to them about an axis passing through them. Thus, the movement means are configured to produce a rotary movement of the first rigid portions 35, and consequently make it possible to move the sabots 29 apart or closer. The first flexible strips 38 are used to connect the second deformable armature 33 to the first rigid armature 32, as well as means for returning the first rigid portions 35 in the position corresponding to the compact configuration.

The rotation of the first rigid portions 35, induces the movement of the sabots towards the outside of the device 20 in one direction of rotation, and to the inside of the device 20 in the opposite direction. Simultaneously, the sabots 29 rotate slightly about themselves to change from a first position corresponding to the compact configuration to a second position corresponding to the extended configuration, and vice versa.

The second rigid portions 36 also rotate about themselves thanks to the first flexible strips 37, following the rotation of the first rigid portions 37. The second rigid portions 36 are used to stiffen the second deformable armature 33.

Such a device 20 may be used in a system for locking, for example a tourbillon, or for coupling, for example between two superposed trains. For example, the diaphragm comes to press against a cam arranged at a distance from the device to trigger the system. In extended position, the diaphragm moves apart and comes to apply a force against the cam or a stud.

Of course, the present invention is not limited to the examples illustrated but is susceptible to various variants and modifications that will become apparent to the person skilled in the art. Other applications are possible, wherein the diaphragm forms for example a cam the geometry of which is variable. The flexible strips may also have a bar shape with flexible necks, or be replaced by a combination of strips, which may be crossed or straight, or even be replaced by a flexible element.

1. A diaphragm deployment device for horology, the device comprising a first rigid armature and a second deformable armature, the first rigid armature and the second deformable armature being connected to one another, so that the second deformable armature changes from a first extended configuration to a second compact configuration, and vice versa, the device defining a first geometry when the second deformable armature is in the first extended configuration, and defining a second geometry smaller than the first geometry, when the second deformable armature is in the second compact configuration, the device extending substantially in the same plane when the second armature is in the first or in the second configuration, wherein the second deformable armature comprises first deformable portions and rigid portions assembled alternately, a first deformable portion connecting a rigid portion to a following rigid portion.

2. The device according to claim 1, wherein the second deformable armature comprises at least one second deformable portion, connecting one or more rigid portions to the first rigid armature.

3. The device according to claim 2, wherein the second deformable portions connect one rigid portion out of two to the first rigid armature.

4. The device according to claim 2, wherein the rigid portions connected to the first rigid armature have shapes different from the other rigid portions.

5. The device according claim 1, wherein each deformable portion comprises a flexible strip connecting by its ends two rigid portions, or a rigid portion and the first rigid armature.

6. The device according to claim 1, wherein the first rigid armature delimits the outer perimeter of the diaphragm, the second deformable armature being arranged inside said perimeter.

7. The device according to claim 6, wherein the first geometry defines a first opening when the second deformable armature is in the first extended configuration, and the second geometry defines a second opening, when the second deformable armature is in the second compact configuration, the first opening being narrower than the second opening.

8. The device according to claim 7, wherein the second deformable armature comprises at least two movable shutters, the shutters being distributed by angular symmetry.

9. The device according to claim 8, each shutter being arranged on a rigid portion different from the second deformable armature.

10. The device according to claim 8, wherein the shutters delimit the first opening of the first configuration and the second opening of the second configuration.

11. The device according to claim 1, wherein the second deformable armature delimits the outer perimeter of the diaphragm, the first rigid armature being arranged inside said perimeter.

12. The device according to claim 11, wherein the first geometry defines a first perimeter when the second deformable armature is in the first extended configuration, and the second geometry defines a second perimeter, when the second deformable armature is in the second compact configuration, the first perimeter being larger than the second perimeter.

13. The device according to claim 12, wherein the second deformable armature comprises at least one sabot, for delimiting the variable perimeter of the device, each sabot being arranged on a rigid portion different from the second deformable armature.

14. The device according to claim 1, wherein it comprises means for moving at least one rigid portion, in order to make the second deformable armature change from the extended configuration to the compact configuration and vice versa.

15. The device according to claim 14, wherein the rigid portion(s) moved by the movement means are rigid portions connected to the first rigid armature.

16. The device according to claim 14, wherein the rigid portion(s) moved by the movement means are rigid portions that are not connected to the first rigid armature.

17. The device according to claim 14, wherein the movement means are configured to produce a substantially straight movement of the rigid portion(s).

18. The device according to claim 13, wherein the movement means are configured to produce a rotary movement of the rigid portion(s).

19. The device according to claim 14, wherein the rigid portions connected to the first rigid armature are subjected to a rotary movement about a pivot point when the second deformable armature changes from the extended configuration to the compact configuration and vice versa.

20. The device according to claim 1, wherein at least one first portion of the first rigid armature and at least one first portion of the second deformable armature form a first one-piece assembly.

21. The device according to claim 20, wherein the whole of the first rigid armature and the whole of the second deformable armature form the first one-piece assembly.

22. The device according to claim 20, wherein a second portion of the first rigid armature and a second portion of the second deformable armature form a second one-piece assembly.

23. The device according to claim 22, wherein the first assembly and the second assembly are superposed on one another.

24. The device according to claim 20, the material of the device is to be selected from silicon, an Ni/P-type nickel-phosphorus alloy or an Fe/Ni/Co/Mo-type steel alloy.

25. A timepiece, comprising a diaphragm-type deployment device according to claim 1.
